(19) United States
(12) Patent Application Publication
(10) Pub. No.: US 2017/0067451 A1
(43) Pub. Date: Mar. 9, 2017

(54) DRIVING ASSEMBLY

(71) Applicant: INNOVATIVE MOTION GMBH, BERLIN (DE)

(72) Inventor: THOMAS LEBERER, BERLIN (DE)

(21) Appl. No.: 15/121,749

(22) PCT Filed: Feb. 24, 2015
(86) PCT No.: PCT/EP2015/053834

§ 371 Date: Aug. 25, 2016

(30) Foreign Application Priority Data
Feb. 27, 2014 (DE) 10 2014 102 557.1

(51) Int. Cl. F03G 3/08; B63B 39/04; B63G 8/14; B64G 1/28

(52) U.S. Cl. CPC F03G 3/08; B64G 1/283; B63B 39/04; B63G 8/14

(57) ABSTRACT

The invention relates to a drive arrangement containing a rotational mass which is supported so as to be rotatable about a first axis, a bearing element supported so as to be rotatable about a second axis extending perpendicular to the first axis having a bearing for supporting the rotational mass, an oscillating body supported so as to be rotatable about a third axis perpendicular to the second axis having a bearing for supporting the bearing element, a drive provided on the oscillating body for generating a rotary movement of the bearing element about the second axis, a housing having a bearing for supporting the oscillating body, and a brake fixed to the housing for braking the rotary movement of the oscillating body in such a way that with each braking operation a driving force is transmitted to the housing.

### CROSS REFERENCE TO RELATED PATENT APPLICATIONS

This patent application is filed herewith for the U.S. National Stage under 35 U.S.C. §371 and claims priority to PCT application PCT/EP2015/053834, with an international filing date of Feb. 24, 2015. The contents of this application are incorporated in their entirety herein.

### STATEMENT REGARDING FEDERALLY-SPONSORED RESEARCH OR DEVELOPMENT

Not applicable.

### TECHNICAL FIELD

The invention relates to a driving assembly. Driving assemblies serve to move a body. A body can be, for example, activated to a linear or an angular movement or a combination thereof. There are various reasons for moving a body. Machines or vehicles are driven in order to fulfill their function. Actuators are driven to adjust a body. With each force generated by a driving device, a counter force is generated in the opposite direction according to the law of the conservation of momentum. The body quasi must “push” itself against something. Rotational movements are initiated by an angular momentum which corresponds to an angular momentum in the opposite direction.

There are locations, for example in space or inside fluids with low density, where it is difficult to move a body. Furthermore, there are situations where a counter force outside the moved body is undesirable.

### BACKGROUND OF THE INVENTION

Under the term “reaction wheel” an actor is known for the positioning of satellites. The reaction wheel generates an angular momentum by means of a motor in order to rotate the satellite about the same axis but in the opposite direction. The overall momentum of the satellite system remains constant. The angular momentum transferred to the satellite is taken up by the reaction wheel in the opposite direction. DE 938571 B discloses a directional gyro for controlling vehicles, in particular airplanes. DE 418559 A discloses a gearing for transmitting forces by means of a gyroscope. DE 1506648A discloses an active position and orbit stabilized communications satellite. DE 16 50 795 discloses a mass power unit with moveable masses.

There are gyroscopes known for stabilizing bodies, for example in space, with respect to their position. However, they do not serve to move a body but only to measure and stabilize their position in space. DE 694 28 531 T2 discloses a double cardan momentum control gyroscope with high momentum.

### BRIEF SUMMARY OF THE INVENTION

It is an object of the invention to provide a driving device without any external counter force. According to an aspect of the invention this object is achieved with a driving assembly comprising:

(a) a rotational mass pivotably supported about a first axis,

(b) a bearing element pivotably supported about a second axis extending perpendicular to the first axis, the bearing element comprising a bearing for bearing the rotational mass,

(c) an oscillation body pivotably supported about a third axis extending perpendicular to the second axis, the oscillation body comprising a bearing for bearing the bearing element,

(d) a driving device provided at the oscillation body for generating a rotational movement of the bearing element about the second axis,

(e) a housing with a bearing for bearing the oscillation body, and

(f) a brake fixed to the housing for braking the rotational movement of the oscillation body in such a way that an angular momentum is transferred to the housing with each braking process.

The driving assembly according to the present invention comprises two rotating bodies rotating about two perpendicular axes—the rotational body and the bearing element around it. Thereby, a Coriolis force is exerted on the oscillation body through the bearing in the oscillation body.

The Coriolis force generally occurs in rotating systems, if a mass in a rotating system is not static but moves relatively to the system. The Coriolis force is directed perpendicular to the moving direction of the body as well as to the rotational axis of the reference system. In the present case, the Coriolis force is directed in opposite directions depending on the angular position of the rotational mass. The oscillation body, therefore, oscillates like a pendulum about the third axis.

The present invention provides, that the oscillation of the oscillation body is phase-wise decelerated by a brake which is fixed to the housing. With each braking process a force is transmitted to the housing, which causes a rotation of the housing. Depending on the phase and the duration of the braking process a rotation of the housing in one direction can be effected. No external counterforce is necessary.

Preferably, it is provided that the rotational mass, the bearing element and/or the oscillation body is connected to a shaft, extending along the corresponding rotational axis and which is pivotably supported. The use of a shaft in the range of the axis enables a simple set-up and good bearing. It is understood, however, that the rotational body may also be pivotably supported in any other way.

The driving device for generating a rotational movement of the bearing element about the second axis may comprise:

(a) a gear wheel with external teeth driving the bearing element at external teeth;

(b) a turbine or blades, driven by pressurized fluid; or

(c) an electro motor with magnets and coils.

The gear wheel with external teeth can be driven by an electro motor or by a fuel motor. A fluid driving device can be operated, for example, with pressurized air or with a water jet. It is understood, however, that any other kind of driving device is suitable, which is in the position to activate a rotation of the bearing element about the second axis.

In a preferred embodiment of the present invention it is provided, that the oscillation body comprises an oscillation body ring which is fixed to an annular braking disk, wherein the brake is engaged to the braking disk. The oscillation body ring can extend in a plane perpendicular to the plane of the braking disk. The rotational body, therefore, extends along the outside around the bearing element. The bearing element rotates inside the oscillation body. The driving device can be provided at the oscillation body ring. The brake, however, acts on the braking disk.

The housing may form an open ball or cylinder. Any other geometric shape is, however, also possible where there is a brake in the range of the braking disk. The body to be driven may be connected to the housing or the housing itself may be the body to be driven.

In a preferred embodiment the brake is an eddy current brake or formed by two brake pads on the inside of the housing which brake the oscillation body at selected phases, while the driving force is transferred to the housing. It is also possible to use effects other than friction for braking. Therefore, the present invention is not limited to the kind of brake. The point in time and the duration of the braking process determines the movement of the housing. It is, therefore, advantageous if the braking activity of the brake can be controlled with respect to the duration and/or its force. Thereby, the movement is adapted to the application.

At least one sensor may be provided at one of the axes, preferably at both axes to determine the braking period and to control the driving device. Each of the sensors provides a signal representing the angular position of the rotating element, i.e. the bearing element and/or the oscillation body. The signals of each sensor are transmitted to the brake control. The braking period is then adapted to the application in accordance with the signals. Similarly, sensors may be provided to determine the power of the generated Coriolis forces. The signals of such sensors may be transmitted to the motor control. The motors are controlled in accordance with such signals.

In a further modification of the invention a motor is provided for driving the rotation mass which is supplied with energy by sliding contacts.

The described driving assembly is suitable for the use for driving and/or deflecting a movement of a transport vehicle for people and/or goods, for automotive applications, for air- and space applications, for nautical applications and/or deep sea applications. In particular, such uses are suitable, where other driving assemblies are not suitable at all or require special efforts. It is understood, however, that the described assembly may be used in any other application also.

Further modifications of the invention are the subject matter of the subclaims. An embodiment is described below in greater detail with reference to the accompanying drawings.

### BRIEF DESCRIPTION OF THE SEVERAL VIEWS OF THE DRAWINGS

FIG. 1 is a perspective view of a rotational mass driven by a motor;

FIG. 2 is a perspective view of a bearing element in the form of a cage with the rotational mass of FIG. 1;

FIG. 3 shows the bearing element of FIG. 2 without the rotational mass;

FIG. 4 is a perspective view of an oscillation body with a bearing element rotationally supported therein;

FIG. 5 shows the oscillation body ring of the oscillation body of FIG. 4 without a braking disk in greater detail;

FIG. 6 shows the oscillation body ring of FIG. 5 with a braking disk in greater detail;

FIG. 7 is a perspective view of a housing with the oscillation body rotationally supported therein;

FIG. 8 separately shows the housing of FIG. 7 in greater detail;

FIG. 9 illustrates the sliding contacts for the energy supply of the driving assembly of the FIGS. 1-8;

FIG. 10 shows the energy supply of the driving assembly of FIGS. 1-9 in greater detail;

FIG. 11 is a perspective view similar to FIG. 4, wherein the gear wheel is in a different, second position;

FIG. 12 is a perspective view similar to FIG. 4 and FIG. 11, wherein the gear wheel is in a different, third position;

FIG. 13 is a perspective view similar to FIG. 4 and FIG. 11;

FIG. 14 shows the components required for the rotation of the bearing element and illustrates its movement;

FIG. 15 is a cross-sectional view of the assembly in FIG. 14;

FIG. 16 shows the assembled driving assembly without housing;

FIG. 17 shows the assembled driving assembly with housing;

FIG. 18 is a schematic representation for illustrating the operation of a driving device for vehicles with two driving assemblies;

FIG. 19 is a perspective view of the assembly of FIG. 4, FIG. 11 and FIG. 13 in a further position for illustration of the moving parts; and

FIG. 20 is a perspective view of the assembly of FIG. 4, FIG. 11 and FIG. 13 in a further position for illustration of the moving parts.

### DETAILED DESCRIPTION OF THE INVENTION

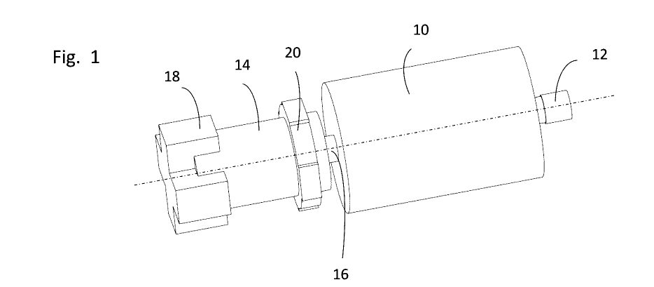

FIG. 1 shows a rotational mass generally designated with numeral 10. In the present embodiment the rotational mass 10 is essentially cylindrical and rotates about its middle axis with a shaft 12. The rotational movement is generated by a motor 14. For this purpose the motor 14 is connected to the rotational mass 10 through a coupling 16. The motor 14 is held by two clamps 18 and 20 in such a way that the rotational mass is centrally positioned.

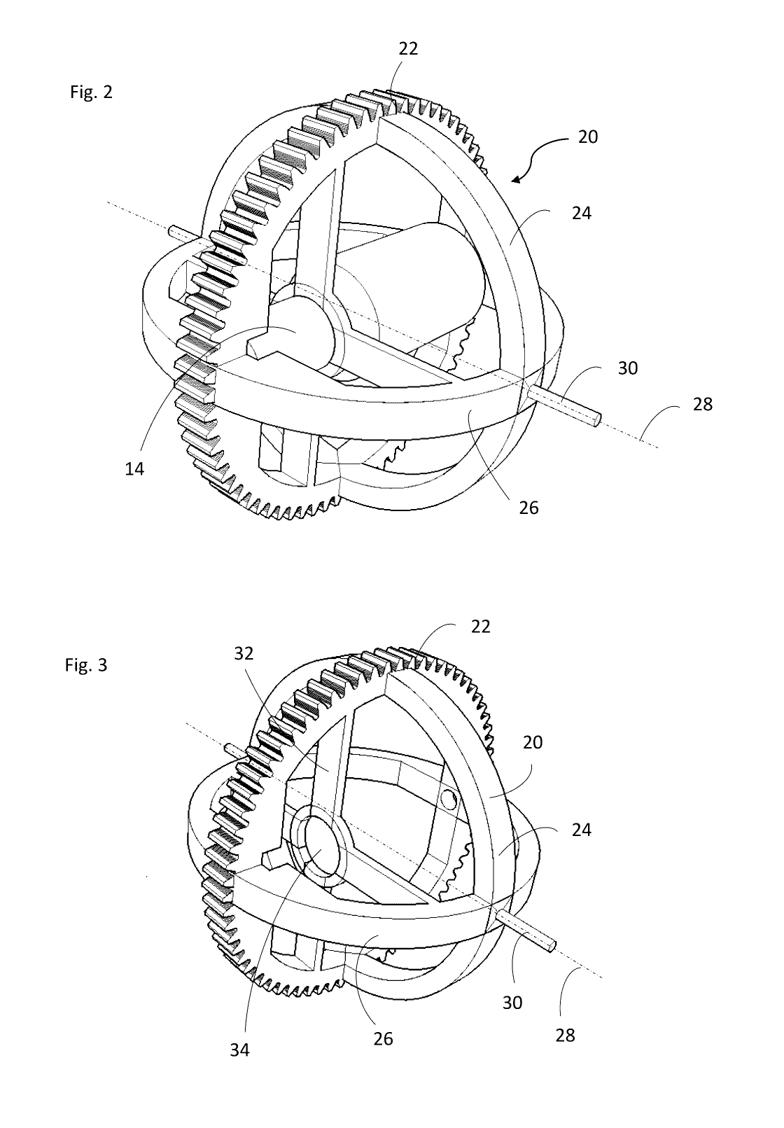

The rotational mass 10 is rotatably supported in a cage generally designated with numeral 20. It is shown in FIG. 2. FIG. 3 shows the cage 20 without a rotational mass. In the present embodiment the cage comprises a gear wheel 22 with external teeth. A first annular bearing element 24 is connected to the gear wheel perpendicular to the gear wheel plane and a second annular bearing element 26 in a plane perpendicular thereto. In the present embodiment the bearing elements 24 and 26 are circular, they may be, however, have any other shape, such as, for example, an elliptic shape. The cage 20 is rotatably supported about an axis 28. The axis 28 extends perpendicular through the gear wheel plane and through the intersection point of the annular bearing elements 24 and 26.

A bearing for bearing the shaft 12 with the rotational mass 10 is provided in the intersection point of the annular bearing element 26 and the gear wheel 22. Accordingly, the rotational mass 10 according to the present embodiment rotates about an axis in the gear wheel plane. A cross-shaped holder 32 is integrated in the plane of the bearing element 24. The holder 32 is provided with a receptacle 34. The motor 14 is untwistably fixed in the receptacle 34. This can be recognized in FIG. 2.

The bearing element 20 is rotatably supported in an oscillation body generally designated with numeral 36. The oscillation body 36 comprises an oscillation body ring 38. The oscillation body ring 38 is separately shown again in FIG. 5. The oscillation body ring 38 of the present embodiment is tightly connected to a brake disk 40. The brake disk 40, therefore, follows every movement of the oscillation body ring 38. The brake disk 40 is also circular. It extends in a plane which runs perpendicular to the plane of the oscillation body ring 38.

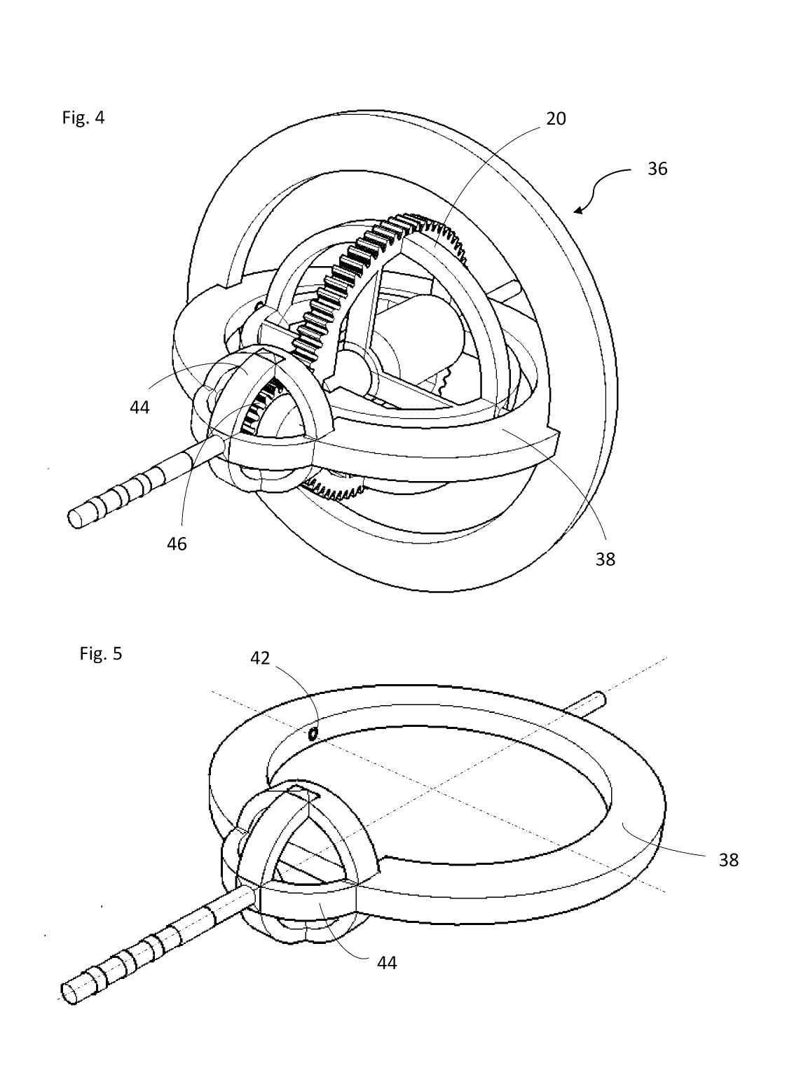

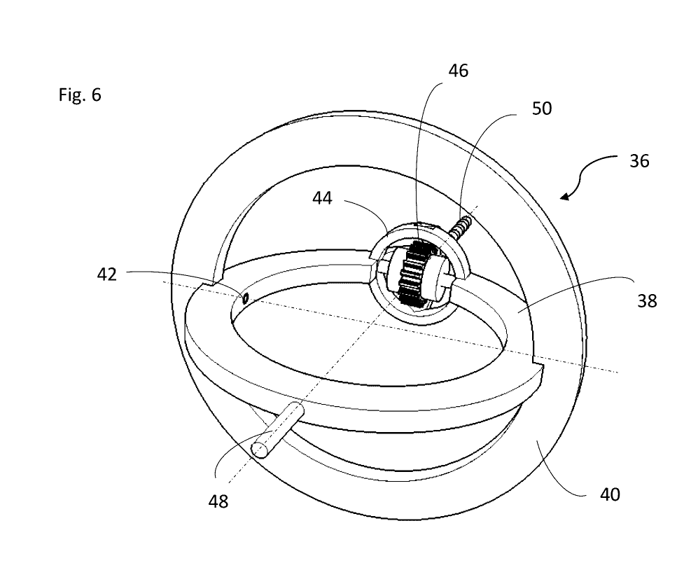

The oscillation body ring 38 is provided with a bearing 42 on its inside. This can be recognized in FIG. 5. The bearing supports the shaft 30 of the cage 20. This is shown in FIG. 4. An open housing 44 is integrated in the oscillation body ring 38. A driving gear wheel 46 is rotatably supported in the housing 44. The driving gear wheel 46 engages with an external teeth of the gear wheel 22 with external teeth. By rotating the driving gear wheel 46 the gear wheel 22 is driven. It may then rotate about the axis 28.

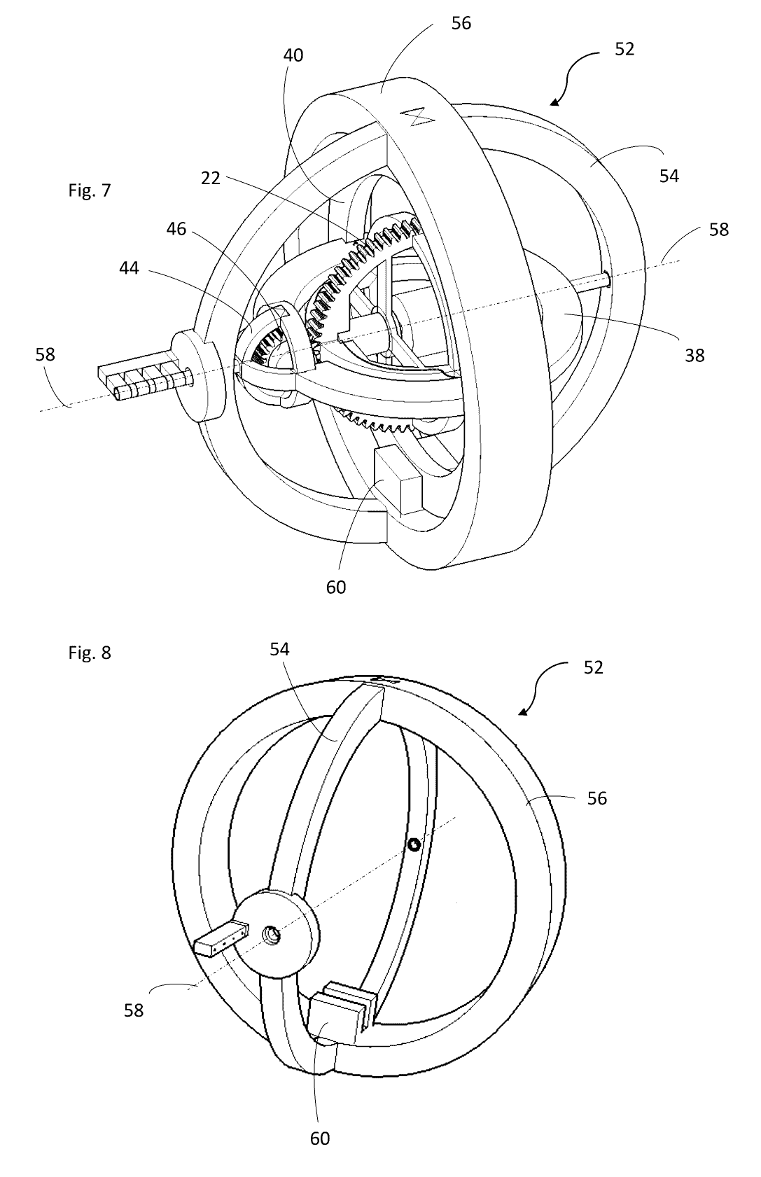

A shaft 48 and 50 is integrated in the oscillation body ring 38. The oscillation body is rotatably supported with the shaft 48 and 50 in a housing 52. In the present embodiment the housing 52 has the shape of an open ball with two annular housing portions 54 and 56. The housing portions 54 and 56 are tightly connected to each other. The shaft 48 and 50 with a corresponding bearing is supported in the housing portion 54. The oscillation body 36 may, therefore, oscillate about a corresponding third axis 58 (see FIG. 7). The axis 58 always extends perpendicular to the rotating axis of the gear wheel 22. Instead of a ball any kind of housing shape can be used, such as, for example, a cylindrical form. The housing may have an open shape, such as in the present embodiment. There are, however, also uses, where it is reasonable to fully close the housing or make a gas- and/or waterproof design where not pressure- and material exchange with the environment is made.

A brake 60 is provided in the housing 52. The brake 60 is tightly installed in the inside of the housing. The brake 60 embraces the brake disk 40 of the oscillation body 36. In the present embodiment the brake 60 is an eddy current brake. Any other brake, such as with brake blocks or the like, is also suitable. The brake 60 is controllable. The braking power, the braking time and the braking duration of the brake 60 can be exactly adjusted and controlled. The angular momentum of the oscillation body 36 is transferred to the housing 52 during the braking process. Thereby, a rotational movement of the housing 52 is effected. During braking the housing 52 quasi follows the oscillating movement.

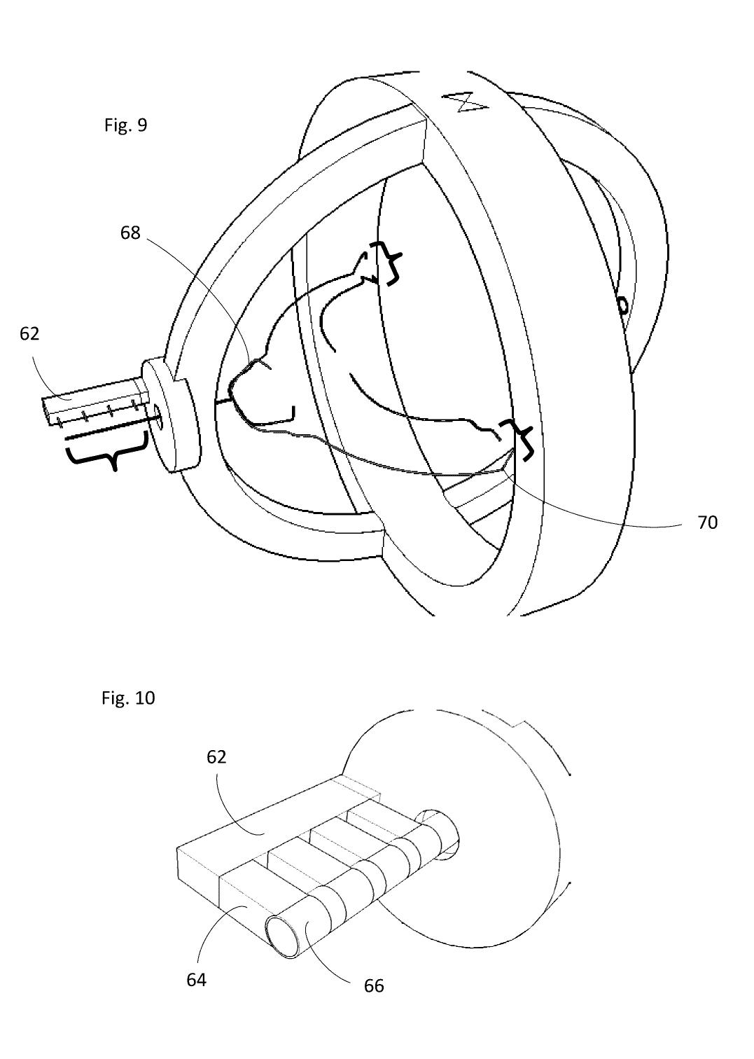

FIGS. 9 and 10 illustrate the energy supply for generating the rotational movement of the rotational mass 10 and the gear wheel 22. An energy source, which in the present embodiment is a battery 62, is contacted by sliding contacts 64 with sliding rings 66. The sliding rings 64 embrace the shaft 50. Electric wires 68 are lead through the shaft 50 and supply the driving device with gear wheel 46 with electric energy. Furthermore, the electric wires, designated with numeral 70 feed the motor 14 with electric energy.

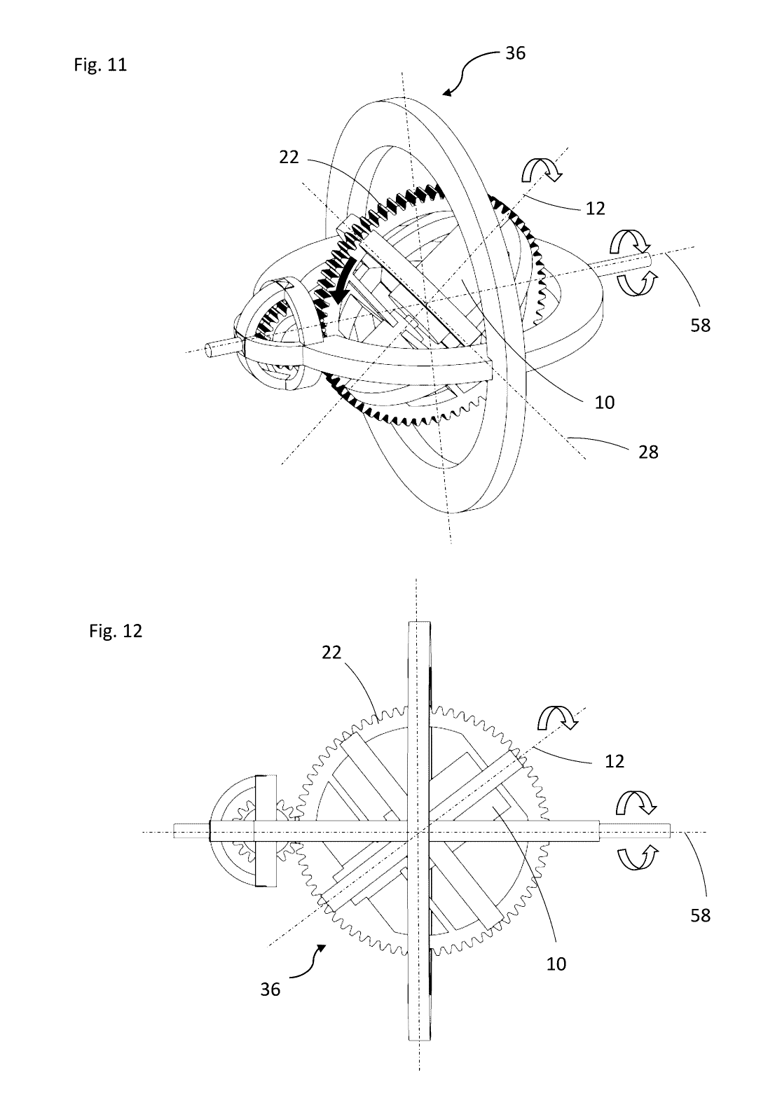

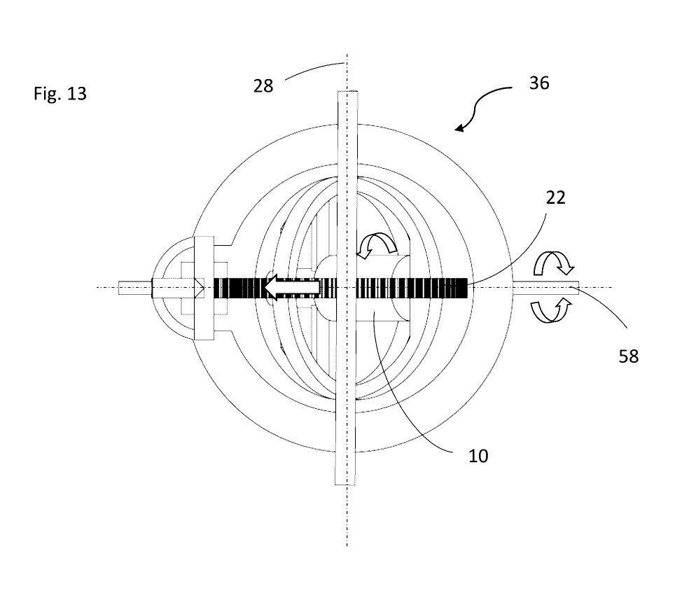

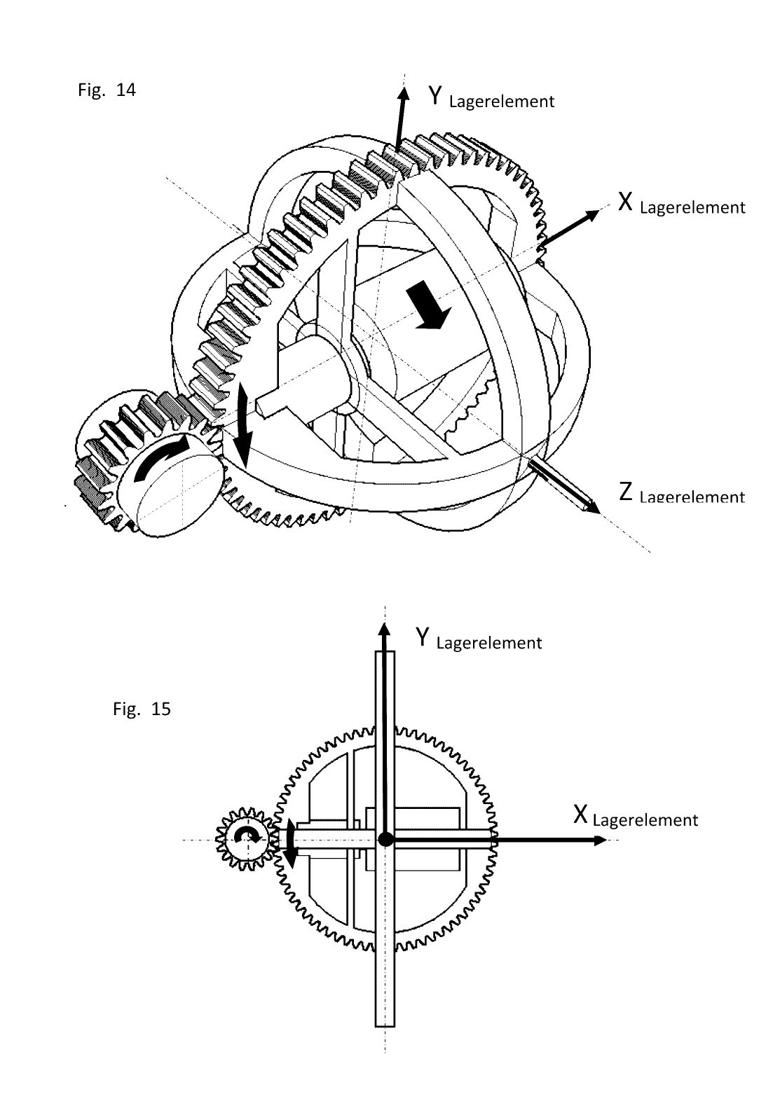

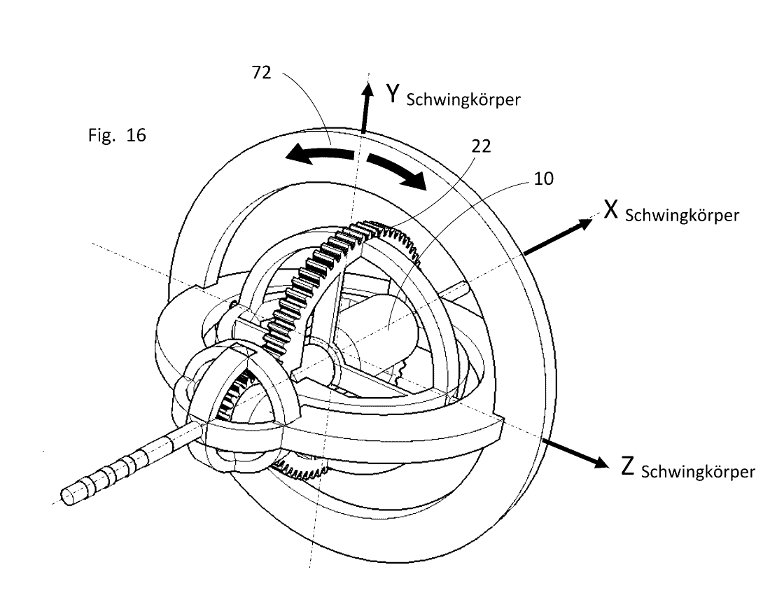

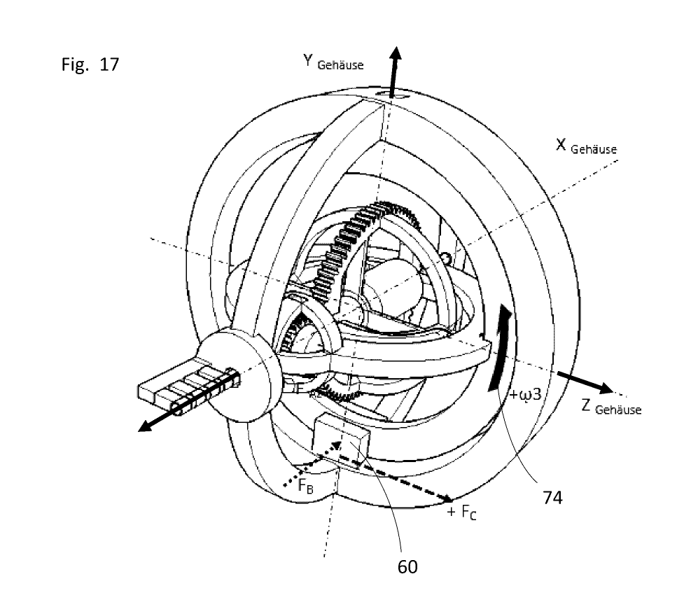

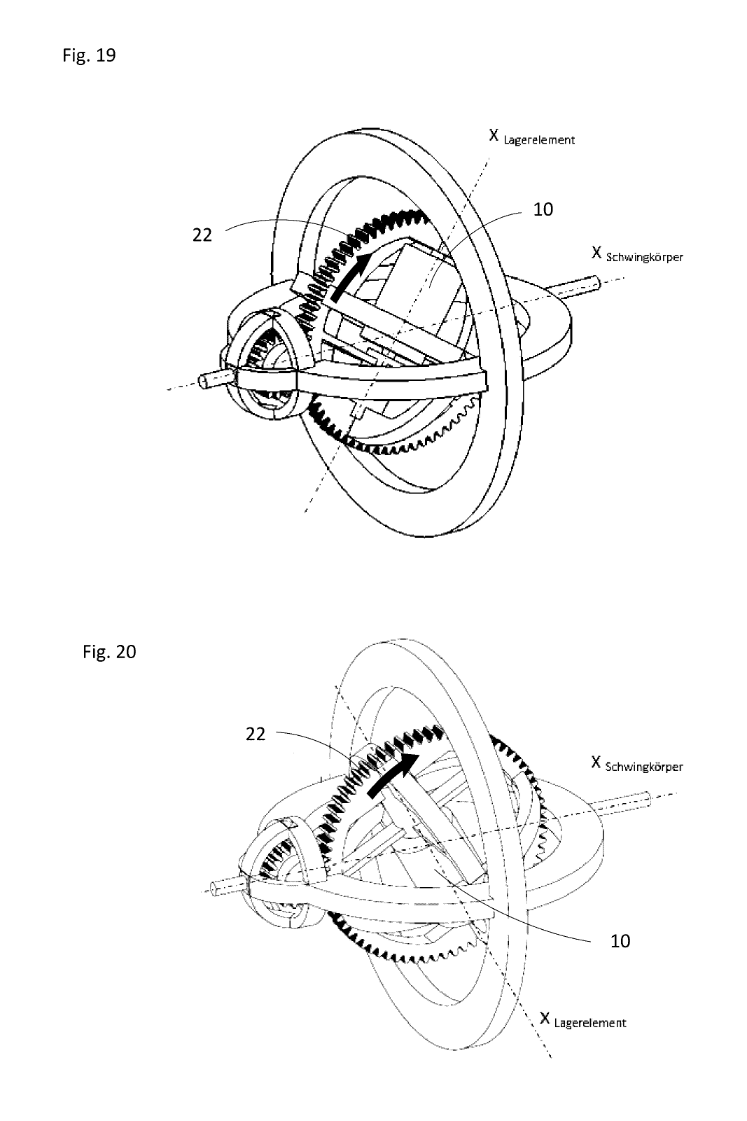

FIGS. 11-17 illustrate the mode of operation of the components. The rotational mass 10 rotates about a first axis. The gear wheel 22 rotates about a second axis perpendicular to the rotational axis of the rotational mass 10. A Coriolis power is generated by such rotation. The oscillation body oscillates about a third axis extending perpendicular to the second axis due to this Coriolis power. The oscillation is illustrated by arrows 72 in FIGS. 16 and 17. The oscillation body periodically oscillates back and forth. If the brake 60 is activated only if the oscillation body oscillates in one preferred direction a directed angular momentum is transferred to the housing. This is represented by arrows 74. The brake is released during back swinging. Overall a rotation of the housing is effected without any external influence. By properly controlling the braking activity a further or smaller rotational movement can be generated. FIGS. 19 and 20 show the oscillating body with the gear wheel 22 and the rotational mass 10 in two different positions. It can be recognized that the rotational axis of the rotational mass 10 is moved as well as the position of the rotational mass itself.

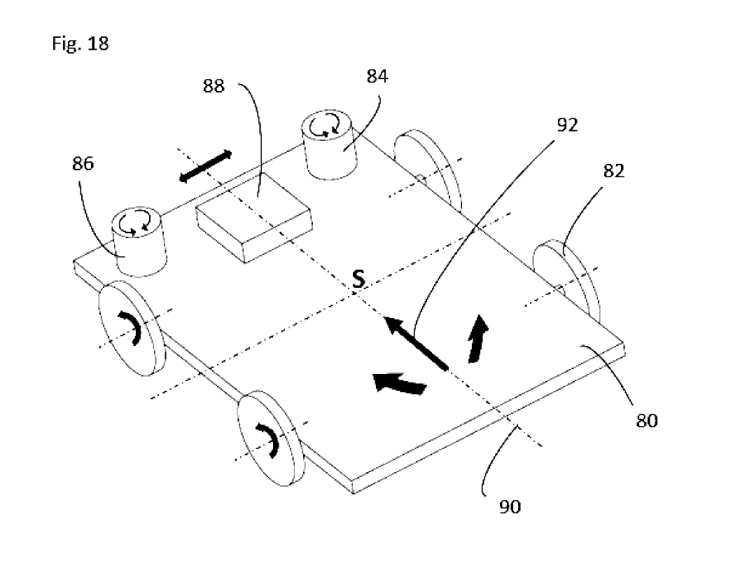

The rotation of the housing can be used in many ways. FIG. 18 is a schematic representation of a vehicle 80 which is shown here with wheels 82. Instead of a vehicle with wheels, however, water vehicles or planes etc. may also be used. The vehicle is provided with two driving assemblies 84 and 86 outside its center of gravity S. By rotating the driving assemblies 84 and 86 in the direction of the arrows the vehicle may be, for example, moved in the direction of the arrow 92 along a moving direction 90. In order to obtain a linear movement the driving assemblies 84 and 86 are alternatingly in the same way but in different angular directions. By changing the rotation, by a suitable control with a control unit 88, for example, the vehicle may be moved in the desired direction.

What is claimed is:

1. A driving assembly comprising:
(a) a rotational mass pivotably supported about a first axis;
(b) a bearing element pivotably supported about a second axis, said second axis extending perpendicular to said first axis, said bearing element comprising a bearing for bearing said rotational mass;
(c) an oscillation body pivotably supported about a third axis extending perpendicular to said second axis, said oscillation body comprising a bearing for bearing said bearing element;
(d) a driving device provided at said oscillation body for generating a rotational movement of said bearing element about said second axis;
(e) a housing with a bearing for bearing said oscillation body; and
(f) a brake fixed to said housing for braking a rotational movement of said oscillation body in such a way that an angular momentum is transferred to said housing with each braking process.

2. The driving assembly of claim 1, and wherein said rotational mass, said bearing element and/or said oscillation body is connected to a shaft, extending along the corresponding rotational axis and which is pivotably supported.

3. The driving assembly of claim 1, and wherein said driving device for generating a rotational movement of said bearing element about said second axis comprises:
(a) a gear wheel with external teeth driving said bearing element at external teeth;
(b) a turbine or blades, driven by pressurized fluid; or
(c) an electro motor with magnets and coils.

4. The driving assembly of claim 1, and wherein said oscillation body comprises an oscillation body ring which is fixed to an annular braking disk, wherein said brake is engaged to said braking disk.

5. The driving assembly of claim 4, and wherein said oscillation body ring extends in a plane perpendicular to the plane of said braking disk.

6. The driving assembly of claim 1, and wherein said housing forms an open ball or cylinder.

7. The driving assembly of claim 1, and wherein said brake is an eddy current brake or formed by two brake pads on the inside of the housing which brake said oscillation body at selected phases, while a driving force is transferred to said housing.

8. The driving assembly of claim 1, and wherein a motor is provided for driving said rotational mass which is fed with energy by sliding contacts.

9. The driving assembly of claim 1, and wherein said brake is provided directly at one of the driven or deflected objects instead of said housing.

10. The driving assembly of claim 1, and wherein one or more driving assemblies according to the preceding claims is provided at a driven or deflected object.

11. The driving assembly of claim 1, and wherein one or more sensors are provided to determine the angular position of said bearing element and/or said oscillation body.

12. The driving assembly of claim 1, and wherein one or more sensors are provided to determine the Coriolis forces.

13. A method of using a driving assembly according to claim 1 for driving and/or deflecting a movement of a transport vehicle for people and/or goods, for automotive applications, for air- and space applications, for nautical applications and/or deep sea applications.
